(19) United States
(12) Patent Application Publication
(10) Pub. No.: US 2002/0141783 A1
(43) Pub. Date: Oct. 3, 2002

(54) Image-forming apparatus and image-forming method

(75) Inventors: Harumi Ishiyama, Shizuoka (JP); Yasunori Chigono, Shizuoka (JP); Jun Hirabayashi, Shizuoka (JP); Norio Takahashi, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaishi, Tokyo (JP)

(21) Appl. No.: 10/050,853

(22) Filed: Jan. 18, 2002

(30) Foreign Application Priority Data
Jan. 23, 2001 (JP) 2001-013975

(51) Int. Cl. G03G 15/02

(52) U.S. Cl. 399/175

(57) ABSTRACT

An image-forming apparatus and an image-forming method using a cleanerless system are disclosed in which a non-contact developing assembly develops an electrostatic latent image with a magnetic one-component developer to form a magnetic-toner image and collects a magnetic toner having remained on the charging object member, a member to be charged is charged by means of a charging assembly having a charging member the surface of which is movable with a velocity differential in the opposite direction with respect to the surface of the charging object member, and conductive particles are present at least at the contact surfaces between the charging member and the charging object member. The velocity differential is from −101% to −400%; the charging member has a surface roughness Ra of from 1 μm to 500 μm; the charging object member has a surface with a contact angle to water of from 86° to 103°; and the magnetic one-component developer is composed of a magnetic toner having at least a binder resin and a magnetic material, and has an average circularity of 0.950 or more.

### BACKGROUND OF THE INVENTION

1. Field of the Invention

This invention relates to an image-forming apparatus used as an electrophotographic apparatus such as a copying machine and a printer, and an image-forming method.

2. Related Background Art

In image-forming apparatus such as electrophotographic apparatus and electrostatic recording apparatus, corona charging assemblies (corona dischargers) have widely been used as charging units for charging (inclusive of charge eliminating) image-bearing members such as photographic photosensitive members and electrostatic recording dielectric members (charging object members or members to be charged) to a necessary polarity and potential.

The corona charging assembly is a non-contact type charging unit. It has a discharge electrode such as a wire electrode and has a shield electrode which surrounds the discharge electrode. Its discharge opening is provided opposite to and in non-contact with an image-bearing member which is a charging object member (or a member to be charged), where a high voltage is applied across the discharge electrode and the shield electrode to cause discharge electric current (corona shower) to take place, to which the surface of the charging object member is exposed to charge the charging object member surface to an intended polarity and potential.

Nowadays, a charging unit of a contact type (contact charging unit) in which a charging member with a voltage kept applied thereto is brought into contact with a charging object member to charge the charging object member electrostatically, have been put into practical use because of their advantages of lower ozone generation and lower power consumption than the corona charging assemblies.

The contact charging unit is a unit in which a conductive charging member of a roller type (charging roller), a fur brush type, a magnetic-brush type or a blade type is brought into contact with a charging object member such as an image-bearing member and a certain charging bias is applied to this charging member (contact charging member or contact charging assembly; hereinafter “contact charging member”) to charge the surface of the charging object member to a certain polarity and potential.

Two types of charging mechanisms are intermingled in the charging mechanism (charging principle) of the contact charging member, which are (1) discharge charging mechanism and (2) direct-injection charging mechanism. Their characteristics are brought out depending on which mechanism is predominant. FIG. 4 shows their typical charging characteristics. Details are as follows:

(1) Discharge Charging Mechanism:

This is a mechanism in which the charging object member surface becomes charged by the discharge phenomenon occurring at any microscopic gap(s) to be formed between the contact charging member and the charging object member.

The discharge charging has a certain discharge threshold value for the contact charging member and charging object member, and hence a voltage greater than the charge potential must be applied to the contact charging member. Though generated in a remarkably smaller quantity than that in corona charging assemblies, a discharge product is inevitably generated in principle, and hence active ions such as ozone are generated.

A roller charging method making use of a conductive roller (charging roller) as the contact charging member is preferable in view of the stability of charging. With the charging mechanism in the roller charging, the discharge charging mechanism is predominant.

The charging roller is formed using a conductive or medium-resistive rubber material or foam. In some rollers, such a material is provided in layers to attain the desired characteristics. The charging roller is provided with an elasticity in order to ensure a uniform contact between it and the charging object member. For this reason, it has a great frictional resistance, and in many cases it is driven with, or at a little different speed from, the rotation of the charging object member. Hence, any unevenness in shape of the roller surface and any deposits on the charging object member tend to cause a non-contact state, so that, with the charging mechanism in the conventional roller charging, the discharge charging mechanism is predominant.

To describe more specifically, when a charging roller is brought into pressure contact with an OPC (organic photoconductor) photosensitive member with a layer thickness of 25 μm as the charging object member, the surface potential of the photosensitive member begins to rise upon application of a voltage of about 640 V or above, and at voltages higher than such threshold value the photosensitive member surface potential linearly increases at a slope of 1 with respect to the applied voltage. This threshold value voltage is defined as charging start voltage Vth (the dotted line in FIG. 4).

In order to obtain a photosensitive member surface potential Vd that is required in electrophotography, a DC voltage of “Vd+Vth” must be applied to the charging roller. The charging performed by applying only a DC voltage to the contact charging member in this way is called “DC charging”.

In the DC charging, however, it has been difficult to control the potential of the photosensitive member at the desired value because the resistance value of the contact charging member varies depending on environmental variations and also because the Vth varies with changes in layer thickness caused by abrasion of the photosensitive member.

Accordingly, in order to achieve more uniform charging, as disclosed in Japanese Patent Application Laid-Open No. 63-149669, “AC charging” is used which is a method of applying to the contact charging member a vibratory voltage produced by superimposing an AC component having a peak-to-peak voltage of 2×Vth or above, on a DC voltage corresponding to the desired Vd. This method aims at a potential-leveling effect which is attributable to AC, where the potential of the member to be charged converges on Vd, the middle of a peak of AC potential, and may less be affected by environment.

However, even in such contact charging units, its fundamental charging mechanism utilizes the phenomenon of discharging from the charging member to the image-bearing member. Hence, as previously stated, the voltage necessary for charging must be at a value not lower than “the image-bearing member surface potential+the discharge threshold value, where ozone is generated in a very small quantity.

When the AC charging is performed in order to achieve uniform charging, there are also problems that ozone may more be generated, that the electric field of AC voltage may cause a vibrating noise (AC charging sound) between the contact charging member and the photosensitive member and that the discharging tends to cause deterioration in the charging object member surface.

(2) Direct-Injection Charging Mechanism:

As disclosed in Japanese Patent Application Laid-Open No. 06-003921 a mechanism is proposed in which electric charges are directly injected from a contact charging member into a charging object member to charge the charging object member surface electrostatically.

This is a method in which a medium-resistance contact charging member is kept in contact with the charging object member surface to inject electric charges directly to the surface of the charging object member without using any discharge mechanism basically, not through any discharge phenomenon. Hence, even if the voltage applied to the charging object member is not higher than the discharge threshold value, the charging object member can be charged to the potential corresponding to the applied voltage (the solid line in FIG. 4). This direct-injection charging mechanism is not accompanied with the generation of ions, and hence any troubles caused by discharge products do not occur.

Stated more specifically, the direct-injection charging is a mechanism in which a voltage is applied to a contact charging member such as a charging roller, a charging brush or a charging magnetic brush to inject electric charges into charge-holding sites such as trap levels present at the charging object member (image-bearing member) surface or conductive particles of a charge injection layer. Since the discharge phenomenon is not predominant, the voltage required for charging is only for the image-bearing member surface, thus the ozone is not generated.

Where a porous roller, such as a sponge roller, having been coated with conductive fine particles for improving contact charging performance is used as a contact charging member, the contact between the contact charging member and the charging object member can be made very close, making it possible to achieve a good charging performance.

With regard to cleanerless systems (toner recycle systems), in transfer type image-forming apparatus, the transfer residual developer (toner) remaining on a photosensitive member (image-bearing member) after transfer is removed from the surface of the photosensitive member by a cleaner (cleaning unit) and becomes a waste toner. In view of environmental conservation, too, it is preferred that this waste toner does not occur. Accordingly, a cleanerless image-forming apparatus is available which is so constructed that any cleaner is not provided and the transfer residual developer remaining on the photosensitive member after transfer is removed by “cleaning-at-development” by means of a developing unit so as to be collected and reused in the developing unit.

The cleaning-at-development is a method in which the developer having remained on the photosensitive member after transfer is collected by charging the photosensitive member at the time of development performed in the next and subsequent steps, followed by exposure to form a latent image, and collecting the residual developer by the aid of a fog take-off bias (fog take-off potential difference Vback, which is a potential difference between the direct-current voltage applied to the developing unit and the surface potential of the photosensitive member) at the time the latent image is developed. According to this method, the transfer residual developer (toner) is collected in the developing unit and reused in the next and subsequent steps, and hence the system can be free from waste toner and also the trouble may less be taken for maintenance. Also, because of the cleanerless system, there is a great advantage in respect of space, making it possible to downsize the image-forming apparatus.

The cleanerless system is, as described above, a system in which the transfer residual toner is not removed from the photosensitive member surface by a cleaner exclusively used therefor, but collected in the developing unit through the part of charging means so as to be utilized again in the developing process. Hence, when the contact charging is used as the means for charging the photosensitive member, it comes into question how the photosensitive member is charged in the state the insulating developer is interposed at the part where the photosensitive member is kept in contact with the contact charging member.

In the above roller charging and fur brush charging, in many cases the transfer residual toner on the photosensitive member is made to spread to become unpatterned and also a great bias is applied to utilize the charging caused by discharge. In the magnetic brush charging, a powder is used as the contact charging member, and hence there is such an advantage that the magnetic brush part formed of the powder conductive magnetic particles softly comes into contact with the photosensitive member to electrostatically charge the photosensitive member. However, it requires a complicated assemblage, and the conductive magnetic particles forming the magnetic brush tends to come off.

In the contact charging unit, in order to prevent uneven charging to effect stable and uniform charging, the contact charging member may be coated with a powder on its surface coming into contact with the surface of the charging object member. Such constitution is disclosed in Japanese Patent Publication No. 7-99442. The contact charging member (charging roller) is rotated as the charging object member (photosensitive member) is rotated (without any velocity differential drive), and hence ozone products may be remarkably less as compared with corona charging assemblies such as Scorotron. However, the principle of charging is still chiefly the discharge charging mechanism like the case of the roller charging described previously. In particular, a voltage formed by superimposing AC voltage on DC voltage is applied in order to attain more stable charging uniformity, and hence the ozone products caused by discharging may more greatly occur. Accordingly, when the apparatus is used over a long period of time and when the cleanerless image-forming apparatus is used over a long period of time, troubles such as smeared images due to ozone products tend to occur.

Japanese Patent Application Laid-Open No. 5-150539 discloses that, in an image-forming method making use of contact charging, at least toner particles and conductive fine particles having an average particle diameter smaller than that of the toner particles are contained in a developer in order to prevent any charging obstruction which may be caused when toner particles or silica particles come to adhere to the surface of the charging means during repetition of image formation for a long time. However, the contact charging used here is totally in the discharge charging mechanism, which is not the direct injection charging mechanism, and has the above problem ascribable to the discharge charging.

Conductive particles may be interposed at the part where the charging object member is kept in contact with a charging member constituted of an elastic foam (elastic sponge), and the charging member may be rotated with a difference in peripheral speed with respect to the surface of the charging object member, where the injection charging which is the direct charging can be materialized without generation of any ozone and in simple construction.

However, in the case of such direct injection charging and cleanerless construction, the insulating, transfer residual toner may accumulate on the charging roller surface, and, in the direct injection charging, any insufficient contact area itself may cause deterioration in charging performance. Also, since the transfer residual toner is present on the charging roller, the toner on the charging roller tends to deteriorate because of rubbing friction between the charging roller and the photosensitive member (drum) in the contact zone. During the long-term use of the apparatus, the toner thus deteriorated may always be kept present on the drum without being collected at the developing zone, so that some toner transferred may cause fog and some toner not transferred remains as it is to tend to cause faulty charging.

Even if such toner is collected, the deteriorated toner having been collected may lower the developing performance to cause an increase in fog and a decrease in image density. Moreover, when the toner is sent forth from the surface of the charging roller, the conductive particles on the charging roller may adhere to the toner particle surfaces and at the same time may be sent forth onto the photosensitive drum, so that the conductive particles on the charging roller may become insufficient.

### SUMMARY OF THE INVENTION

An object of the present invention is to solve the above problems and provide an image-forming apparatus and an image-forming method using a cleanerless system which can maintain stable charging performance and image characteristics even in long-term service.

To achieve the above object, the present invention provides an image-forming apparatus comprising:

a charging object member (or a member to be charged);

a charging assembly which is in contact with the charging object member to electrostatically charge the charging object member;

an exposure assembly which forms an electrostatic latent image on the charging object member by exposure;

a non-contact developing assembly making use of a magnetic one-component developer, which develops the electrostatic latent image with the magnetic one-component developer to form a magnetic-toner image and collects a magnetic toner remaining on the charging object member; and

a transfer charging assembly which transfers to a recording medium the magnetic-toner image formed on the charging object member;

wherein the charging assembly comprises a charging member constituted of an elastic body having the shape of a roller and having a porous material at least on its surface, the surface of the charging member is movable with a velocity differential in the opposite direction with respect to the surface of the charging object member, and conductive particles are present at least at the contact surfaces between the charging member and the charging object member;

the velocity differential being from −101% to −400%;

the charging member having a surface roughness Ra of from 1 μm to 500 μm;

the charging object member having a surface with a contact angle to water of from 860 to 103°;

the magnetic one-component developer comprising a magnetic toner having at least a binder resin and a magnetic material, and the magnetic one-component developer having an average circularity of 0.950 or more as determined from the following equations:

$$C i r c u l a r i t y ( C i ) = \frac{\begin{matrix}Ci r c u m fe r e nt i a l l e n g t h of a \\ circle with the same area \\ as projected particle image\end{matrix}}{\begin{matrix}Circumferential length of \\ projected particle image\end{matrix}} \qquad Equation ( 1 )$$

$$A v e r a g e c i r c u l a r i t y ( \overline{C} ) = {\sum }_{i = 1}^{m} C i / m \qquad Equation ( 2 )$$

The present invention also provides an image-forming method comprising:

charging a charging object member (or a member to be charged) electrostatically by means of a charging assembly which is in contact with the charging object member;

exposing the charging object member thus charged, by means of an exposure assembly to form an electrostatic latent image on the charging object member;

developing the electrostatic latent image by means of a non-contact developing assembly having a magnetic one-component developer, to form a magnetic-toner image on the charging object member;

transferring the magnetic-toner image formed on the charging object member, to a recording medium by means of a transfer charging assembly;

charging by means of the charging assembly the charging object member having thereon a magnetic toner remaining after transfer;

exposing the charging object member thus charged, by means of the exposure assembly to form an electrostatic latent image on the charging object member;

developing the electrostatic latent image with the magnetic one-component developer to form a magnetic-toner image on the charging object member, and collecting in the non-contact developing assembly the magnetic toner remaining on the charging object member; and

transferring the magnetic-toner image formed on the charging object member, to a recording medium by means of the transfer charging assembly;

wherein the charging assembly comprises a charging member constituted of an elastic body having the shape of a roller and having a porous material at least on its surface, the surface of the charging member is moved with a velocity differential in the opposite direction with respect to the surface of the charging object member, and conductive particles are present at least at the contact surfaces between the charging member and the charging object member;

the velocity differential being from −101% to −400%;

the charging member having a surface roughness Ra of from 1 μm to 500 μm;

the charging object member having a surface with a contact angle to water of from 86° to 103°;

the magnetic one-component developer comprising a magnetic toner having at least a binder resin and a magnetic material, and the magnetic one-component developer having an average circularity of 0.950 or more as determined from the following equations.

$$\begin{matrix}C i r c u l a r i t y ( C i ) = \frac{\begin{matrix}Ci r c u m fe r e nt i a l l e n g t h of a \\ circle with the same area \\ as projected particle image\end{matrix}}{\begin{matrix}Circumferential length of \\ projected particle image\end{matrix}} & Equation ( 1 ) \\ A v e r a g e c i r c u l a r i t y ( \overline{C} ) = {\sum }_{i = 1}^{m} C i / m & Equation ( 2 )\end{matrix}$$

### BRIEF DESCRIPTION OF THE DRAWINGS

FIG. 1 is a schematic view of the construction of an image-forming apparatus according to the present invention.

FIG. 2 is a cross-sectional view showing the layer construction of a photosensitive drum A.

FIG. 3 is a cross-sectional view showing the layer construction of a photosensitive drum A.

FIG. 4 is a graph showing discharge charging and injection charging characteristics.

### DESCRIPTION OF THE PREFERRED EMBODIMENTS

In the image-forming apparatus of the present invention which do not have any cleaning unit, the insulating transfer residual toner which is inhibitory to the injection charging can easily roll into the charging contact zone even when it comes into that zone, and, even when there are some areas having become not chargeable because the transfer residual toner has once been present there, the toner can roll to move and come in contact with other normal contact areas, and also the charging member surface comes into contact at its other fresh areas according to its rotation. Hence, good charging preformance can be achieved. Thus, uniform charging can be accomplished even in ozoneless and cleanerless apparatus.

The developer (toner) used in the present invention, both the toner having passed the contact zone and the toner not having passed the contact zone move to the downstream part of the contact zone through the charging roller surface, can readily move to the photosensitive drum surface on account of the potential difference between the photosensitive drum and the charging member. Hence, the toner does not stay on the charging roller surface and does not come into contact with the photosensitive drum many times, so that the toner may less deteriorate. Thus, any fog and density decrease due to such deteriorated toner do not occur, and good developing performance can stably be achieved even in long-term service.

Moreover, when the toner is sent forth from the surface of the charging roller onto the photosensitive drum, it may be hard for the conductive particles on the charging roller to adhere to the toner particle surfaces, and hence less conductive particles may be sent forth onto the photosensitive drum together with the toner. This enables the conductive particles to be fed in a smaller quantity, and makes it possible to stably control the quantity of the conductive particles on the charging roller throughout running. Thus, stable images can be formed throughout running.

On account of the foregoing, a cleanerless image-forming apparatus can be provided which can perform ozoneless charging taking environment into consideration and also does not produce waste toner.

A cleanerless image-forming apparatus according to an embodiment of the present invention is described below.

Apparatus Construction:

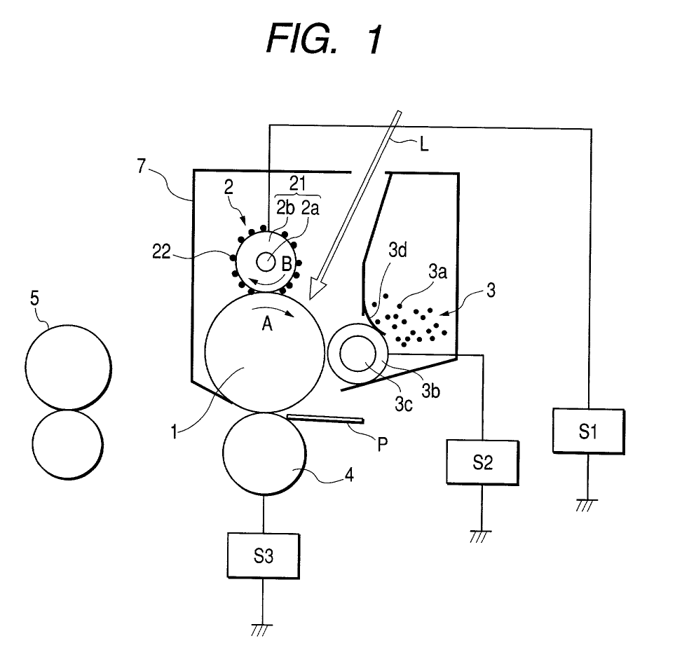

This image-forming apparatus has, as shown in FIG. 1, a photosensitive drum 1 as the charging object member and provided around it a charging assembly 2, an exposure unit L, a developing assembly 3, a transfer charging assembly 4 and a fixing assembly 5. The photosensitive drum 1 and the charging assembly 3 are so constructed as to be held in an integral-type cartridge 7. The embodiment of the apparatus is by no means limited to this.

Each unit or assembly is described below.

Charging Unit:

The charging unit of this example is, as shown in FIG. 1, constituted chiefly of a conductive elastic roller 21 (hereinafter “charging roller”) and conductive particles 22 intended for the acceleration of charging (hereinafter “charging accelerator particles”). The surface of the charging roller 21 are previously coated with the charging accelerator particles in the manner described later. The photosensitive drum is electrostatically charged in the state the charging roller holds the charging accelerator particles thereon. Also, the charging accelerator particles are interposed between the charging roller and the photosensitive drum so that a velocity differential can be provided between the both. Hence, a high contact performance can be achieved by providing such velocity differential. As for the construction, the charging roller may rotatingly be driven to provide the velocity differential between the photosensitive drum and the charging roller. The charging roller may preferably be so constructed that its rotational direction B is opposite to the movement direction A of the photosensitive drum surface.

With such a construction, a high charging efficiency can be achieved which has not been achieved in any conventional roller charging, and a potential substantially equal to the potential applied to the charging roller can be imparted to the charging object member. As the bias necessary for charging, a voltage is sufficient which corresponds to the potential necessary for the charging object member. Thus, a charging system is materialized which does not make use of any discharge phenomenon and can be stable and safe.

The velocity differential between the photosensitive drum and the charging roller may preferably be from −101% to −400%. If the velocity differential is smaller than −101%, the contact performance necessary for charging may be insufficient. If it is greater than −400%, the rubbing friction with the photosensitive drum may occur so frequently that the photosensitive drum surface may wear to be shortened in its lifetime.

Chief members constituting this charging assembly are described below.

Charging Roller:

The charging roller 21 is prepared by forming on a mandrel 2a a medium-resistance layer 2b comprised of an elastic foam. The medium-resistance layer 2b is formulated using a resin (e.g., urethane resin), conductive particles (e.g., carbon black), a blowing agent and so forth, and is formed on the mandrel 2a in the shape of a roller. Thereafter, the surface is optionally polished to prepare an elastic conductive roller 21 of 12 mm in diameter and 200 mm in long-dimension length.

Roller resistance of this example was measured to find that it was 100 kΩ. To measure it, in a state that the roller 21 is pressed against an aluminum drum of 30 mm in diameter so that a load of 9.8 N (1 kg) in total pressure is applied to its mandrel, a voltage of 100 V is applied to the mandrel 2b and the aluminum drum. Here, it is important for the charging roller 21 to function as an electrode. It is necessary for the roller to be endowed with an elasticity to provide a sufficient state of contact and at the same time to have an electrical resistance low enough to charge the moving charging object member. Meanwhile, any leak of voltage must be prevented when any defects such as pinholes are present in the charging object member. Hence, the roller may preferably have an electrical resistance of from 10⁴ to 10⁷ Ω in order to attain a sufficient charging performance and anti-leaking.

With regard to the hardness of the charging roller, a too low hardness may provide no stable shape to make the contact performance poor. A too high hardness not only can not ensure the charging nip, but also may make any microscopic contact performance poor. Hence, the charging roller may preferably have a hardness in the range of from 25 degrees to 50 degrees as Asker-C hardness.

Materials for the charging roller elastic body may include EPDM (ethylene-propylene-diene-methylene rubber), urethane rubber, NBR (nitrile-butadiene rubber) and silicone rubber, as well as rubbers such as IR (isoprene rubber) in which a conductive substance such as carbon black or a metal oxide has been dispersed. Also, without dispersing any particular conductive substance, the electrical resistance may be regulated by the use of an ion-conductive material, or the electrical resistance may also be regulated by blending the metal oxide and the ion-conductive material.

The charging roller must hold the conductive particles thereon in a high density, and hence it is required to have a certain roughness. It may preferably have a hardness of from 1 μm to 500 μm as average hardness Ra. If it has an Ra of less than 1 μm, it may have an insufficient surface area for holding the conductive particles thereon, and also, when any insulator (e.g., the toner) adheres to the charging roller surface layer, its surrounding areas can not come into contact with the surface of the photosensitive drum, resulting in a lowering of charging performance. If on the other hand it has an Ra of more than 1 μm, the unevenness of the charging roller surface may lower the in-plane charging uniformity of the photosensitive drum (charging object member). The Ra in this example is 40 μm.

To measure the average hardness Ra, the profile and Ra of the roller surface are measured in non-contact, using a surface-profile-measuring microscope VF-7500 or VF-7510, manufactured by Keyence Co., and using an objective lens of 1,250 magnifications to 2,500 magnifications.

Charging Accelerator Particles:

In this example, using a brush, the surface of a charging roller before use is uniformly coated with conductive zinc oxide particles 22 having a specific resistance of 1×10³ Ω·cm and an average particle diameter of 1.2 μm.

As materials for such particles, usable are conductive inorganic particles such as other metal oxides, their mixture with an organic matter, or various conductive particles obtained by subjecting these to surface treatment.

In order to deliver and receive electric charges through particles, the charging accelerator particles may preferably have a specific resistance of 1×10¹² Ω·cm or below. Here, the specific resistance is measured by the tablet method and determined by normalization. About 0.5 g of a powder sample is put in a cylinder of 2.26 cm² in bottom area, and a pressure of 147 N (15 kg) is applied to upper and lower electrodes and at the same time a voltage of 100 V is applied to measure the resistance value, followed by normalization to calculate the specific resistance.

The conductive particles may preferably have an average particle diameter of 10 μm or less in order to achieve a high charging efficiency and charging uniformity. In the present invention, the particle diameters of particles making up agglomerates are defined as an average particle diameter of the agglomerates themselves. The average particle diameter of the conductive particles is determined by sampling at least 100 particles from observation on an electron microscope, calculating a volume particle size distribution on the basis of the horizontal-direction maximum chord length, and regarding its 50% average particle diameter as the average particle diameter.

The conductive particles not only may be present in the state of primary particles, but also may be present in the state of agglomerates of secondary particles without any problem. In whatever state of agglomeration, the form of particles is not important as long as the agglomerates themselves can function as conductive particles.

Especially when used in the charging of the photosensitive drum, the conductive particles may preferably be white or nearly transparent so that they do not obstruct the exposure for forming latent images. In addition, taking account of the fact that the conductive particles may partly be transferred from the surface of the photosensitive drum to a recording medium P, the conductive particles may preferably be colorless or white particles when used in color recording. Also, in order to prevent any light scattering from being caused by the conductive particles at the time of imagewise exposure, their particle diameter may preferably be not larger than the size of a constituent pixel, and more preferably not larger than the average particle diameter of the toner. As the minimum value of their particle diameter, 10 nm (0.010 μm) is considered to be the limit as a size for them to be stable as particles.

Developing Assembly:

The developing assembly in this example is a developing assembly which is in non-contact with the photosensitive drum and makes use of a magnetic one-component developer (magnetic toner) blended with the conductive particles. The conductive particles used here are the same ones as the conductive particles described above. The developing assembly 3 is constituted of a developing sleeve 3b provided internally with a magnet roll 3c and a regulation blade 3d. While a toner 3a held in the developing assembly is transported on the sleeve, it is regulated for its layer thickness and provided with electric charges by the regulation blade 3d, and is introduced to the developing zone, where the electrostatic latent image formed on the photosensitive drum 1 is developed to form a magnetic toner image. At the time of this development, the electrostatic latent image is developed and at the same time the conductive particles are fed from the developing zone onto the photosensitive drum.

How the apparatus operates is described below.

Operation of Charging Assembly:

How the charging assembly 2 of this example operates is described. The photosensitive drum 1 has the shape of a drum of 30 mm in diameter, and is rotated at a constant speed of 50 mm/sec in peripheral speed. The charging roller 21 is driven at about 80 rpm so that the charging roller surface moves at a speed equal to the photosensitive drum (velocity differential: −200%) in the direction opposite to each other, and a DC voltage of −700 V is applied to the roller mandrel 2a from a bias means S1. Thus, the photosensitive drum surface is charged to a potential equal to the applied voltage.

How the whole apparatus operates is described below.

Operation of the Whole Apparatus:

A DC voltage of −700 V is applied to the above charging roller mandrel 2a, and the surface of the photosensitive drum 1 is charged to a potential substantially equal to the applied voltage. Thereafter, image areas are scanned by means of an exposure assembly L such as a laser scanner in accordance with print patterns to form an electrostatic latent image on the photosensitive drum 1. Thereafter, the electrostatic latent image on the photosensitive drum 1 is developed with the magnetic toner 3a kept charged triboelectrically, to form a magnetic toner image as a visible image. The magnetic toner image developed on the photosensitive drum is finally transferred and fixed to the recording medium P by means of the fixing assembly 5 to obtain a recorded image. Thereafter, for the purpose of recycling the toner, the magnetic toner having become a transfer residual toner reaches the charging contact zone and is mingled with the conductive particles while being agitated by the aid of microscopic protrusions of the charging roller surface. The charged conductive particles fed onto the photosensitive drum together with the magnetic toner are also left on the photosensitive drum without being transferred to the transfer medium (recording medium) and reach the charging zone, where they are held on the charging roller surface. Hence, close contact performance and contact resistance can be kept for the photosensitive drum. Thus, the direct charging can be effected. Then, the magnetic toner thus mingled is, without entering the interior of the charging roller, charged to the polarity the magnetic toner is to have originally, by the aid of its friction with the photosensitive drum and conductive particles, and is then sent forth from the charging roller, where, in the next developing step, it is collected in the developing assembly or takes part in the development.

The developer used in the present invention is described below.

Developer:

To prepare the developer (toner) according to the present invention, the following methods are used.

As one method, a pulverization method currently often used is employed. For example, a binder resin, a wax, a metal salt or metal complex, a magnetic material also functioning as a colorant, and optionally a charge control agent and other additives are thoroughly mixed by mean of a mixer such as a Henschel mixer or a ball mill, thereafter the mixture obtained is melt-kneaded by means of a heat kneading machine such as a heat roll, a kneader or an extruder to make resins compatible with one another, in which a metal compound and a dispersant are dispersed or dissolved, followed by cooling for solidification and thereafter pulverization and classification, thus the magnetic toner according to the present invention can be obtained. In the step of classification, a multi-division classifier may preferably be used in view of production efficiency. Thereafter, surface treatment is made by the method used in Examples given later.

As another method, a polymerization method is available. Here, as an example, the production of the magnetic toner by suspension polymerization is described. In this suspension polymerization, a polymerizable monomer and a magnetic material (and also optionally a polymerization initiator, a cross-linking agent, a charge control agent and other additives) are uniformly dissolved or dispersed to form a polymerizable monomer composition, and thereafter this polymerizable monomer composition is dispersed in a continuous phase (e.g., an aqueous phase) containing a dispersion stabilizer by means of a suitable stirrer to simultaneously carry out polymerization, obtaining a magnetic toner having desired particle diameters. In the magnetic toner (hereinafter “polymerization magnetic toner”) obtained by this suspension polymerization, individual toner particles stand uniform in a substantially spherical shape, hence the developer (magnetic toner) which satisfies the requirement on physical properties, the average circularity of 0.950 or more, optimum for the present invention can be easily obtained. Moreover, such a developer can also have a relatively uniform charge quantity distribution and has a high transfer performance.

However, where a usual magnetic material is incorporated in the polymerization magnetic toner particles, it is difficult to keep the magnetic material from being laid bare out of the surfaces of the magnetic toner particles. In addition, not only because of a lowering of fluidity and charging performance of the magnetic toner particles, but also because of a strong interaction between the magnetic material and the water when the magnetic toner is produced by suspension polymerization, the magnetic toner having the average circularity of 0.950 or more may be hard to obtain. This is presumed to be due to the fact that (1) the particles of the magnetic material are commonly hydrophilic and hence tend to be present at the magnetic-toner particle surfaces, and (2) the magnetic material moves disorderedly when the aqueous medium is stirred and the surfaces of suspended particles comprised of monomers are dragged thereto, so that their shapes are distorted and are hard to make round. In order to solve such problems, it is important to modify the surface properties the particles of the magnetic material have.

As a method of surface-modifying the particles of the magnetic material, a method of making hydrophobicity higher is available as an example, which may specifically include silane coupling treatment and titanium coupling treatment.

Measurement of Average Circularity of Developer:

The average circularity referred to in the present invention is used as a simple method for expressing the shape of particles quantitatively. In the present invention, the shape of particles is measured with a flow type particle image analyzer FPIA-1000, manufactured by Toa Iyou Denshi K.K., and the circularity (Ci) of respective particles measured is individually calculated on a group of particles having a circle-equivalent diameter of 3 μm or larger, according to the following Equation (1). Further, as shown in the following Equation (2), the value obtained dividing the sum total of circularity of all particles measured by the number (m) of all particles is defined to be the average circularity (\overline{C}).

$$\begin{matrix}C i r c u l a r i t y ( C i ) = \frac{\begin{matrix}Ci r c u m fe r e nt i a l l e n g t h of a \\ circle with the same area \\ as projected particle image\end{matrix}}{\begin{matrix}Circumferential length of \\ projected particle image\end{matrix}} & Equation ( 1 ) \\ A v e r a g e c i r c u l a r i t y ( \overline{C} ) = {\sum }_{i = 1}^{m} C i / m & Equation ( 2 )\end{matrix}$$

The measuring device “FPIA-1000” used in the present invention employs a calculation method in which, in calculating the circularity of each particle and thereafter calculating the average circularity, particles are divided into division ranges, which are divided into 61 classes as circularities of from 0.40 to 1.00, in accordance with the resultant circularities, and the average circularity are calculated using the center values and frequencies of divided points. Between the values of the average circularity calculated by this calculation method and the values of the average circularity calculated by the above calculation equation which uses the circularity of each particle directly, there is only a very small error, which is at a level that is substantially negligible. Accordingly, in the present invention, such a calculation method may be used in which the concept of the calculation equation directly using the circularity of each particle is utilized and is partly modified for the reasons of handling data, e.g., shortening the calculation time and simplifying the operational equation for calculation.

A specific method for the measurement is as follows: In 10 ml of water in which about 0.1 mg of a surface-active agent has been dissolved, about 5 mg of the developer or toner is dispersed to prepare a dispersion. Then the dispersion is exposed to ultrasonic waves (20 kHz, 50 W) for 5 minutes and the dispersion is made to have a concentration of 5,000 to 20,000 particles/μl, where the measurement is made using the above analyzer to determine the average circularity of the group of particles having a circle-equivalent diameter of 3 μm or larger.

The circularity referred to in the present invention is an index showing the degree of surface unevenness of developer or toner particles. It is indicated as 1.000 when the particles are perfectly spherical. The more complicated the surface shape of the particles is, the smaller the value of circularity is.

In the above measurement, the reason why the circularity is measured only on a group of particles having a circle-equivalent diameter of 3 μm or larger is that the group of particles of external additives that is present independently of toner particles are included in a large number in the group of particles having a circle-equivalent diameter smaller than 3 μm, which may affect the measurement to make it impossible to accurately estimate the circularity of toner particles.

Addition of Conductive Particles to Developer:

As the conductive particles to be added to the developer, the same particles as the charging accelerator particles described previously are used. The conductive particles may be added, as an optimum amount, in an amount of from 0.01 to 20 parts by weight based on 100 parts by weight of magnetic toner particles. If they are less than 0.01 part by weight, the charged conductive particles may insufficiently be fed, making it impossible to maintain charging performance. If on the other hand they are more than 20 parts by weight, the charged conductive particles may be fed in excess to cause the screening of light at exposed areas although they are white or transparent fine particles.

Photosensitive Member:

Two types of photosensitive members (photosensitive drums) are described below.

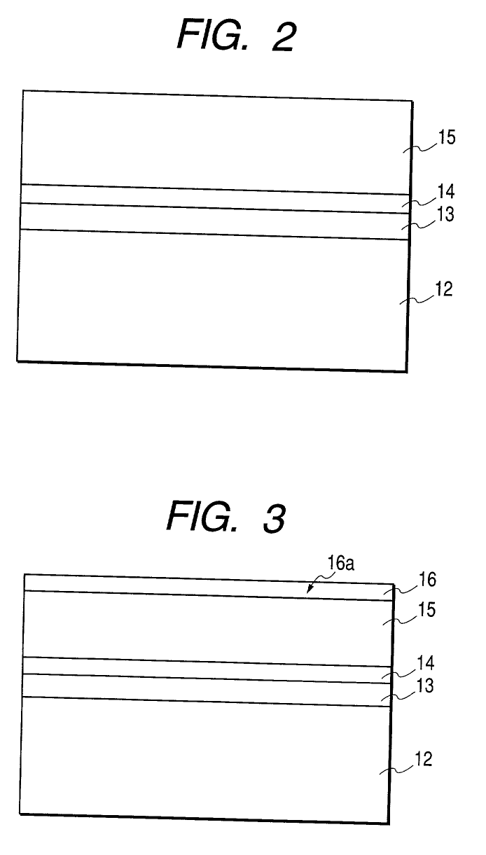

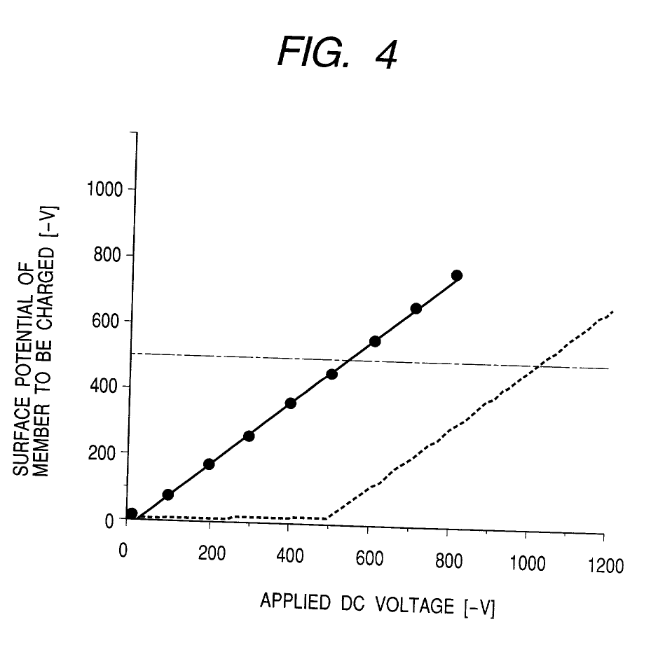

FIG. 2 cross-sectionally illustrates the layer construction of a photosensitive drum A. The photosensitive drum A is a commonly available organic photosensitive drum comprising an aluminum drum substrate 12, and a positive-charge injection preventive layer 13, a charge generation layer 14 and a charge transport layer 15 superposed thereon in this order by coating. The charge transport layer 15 has a characteristic construction in this example, which contains Teflon [a trademark of Du Pont; a fluorine resin, polytetrafluoroethylene (PTFE)] so as to make higher the surface contact angle to water.

The charge transport layer is commonly formed by applying a solution prepared by dissolving a charge-transporting material together with a binder. As examples of an organic charge-transporting material, it may include hydrazone compounds, stilbene compounds, pyrazoline compounds, oxazole compounds and triarylamine compounds. Any of these charge-transporting materials may be used alone or in combination.

In this example, a hydrazone is dispersed in a polycarbonate resin, and particles of the fluorine resin (Teflon) are dispersed on the basis of the total solid content of these.

Then, FIG. 3 cross-sectionally illustrates the layer construction of a photosensitive drum B. The photosensitive drum B is a commonly available organic photosensitive drum comprising an aluminum drum substrate 12, and superposed thereon a positive-charge injection preventive layer 13, a charge generation layer 14 and a charge transport layer 15 superposed thereon in this order by coating, and a surface layer 16 is further formed thereon by coating so that a photosensitive drum improved in surface strength can be used. The surface layer is formed by coating a dispersion prepared by mixing and dispersing ultrafine SnO₂ particles 16a (particle diameter: about 0.03 μm), particles of fluorine resin (Teflon) as a lubricant and a polymerization initiator in a photocurable acrylic resin, followed by photocuring to form a film.

In the case where the surface layer is formed on the charge transport layer, the binder resin for the charge transport layer may be selected from insulating resins or organic photoconductive polymers. For example, the insulating resins may include polycarbonate, polyarylate, polyester, polyacrylate and polyurethane. The organic photoconductive polymers may also include polyvinyl carbazole, polyvinyl anthracene and polyvinyl pyrene.

For a construction in which a surface layer is formed on the charge transport layer, for example, a powder of polytetrafluoroethylene is dispersed as a low-surface-energy-providing agent in the insulating resin like the foregoing. Such a low-surface-energy-providing agent may be added in an amount of from 10% to 100% by weight, and preferably from 20% to 50% by weight, based on the total weight of the surface layer. If it is added in an amount less than 10% by weight, the intended effect may insufficiently be obtained. If it is more than 100% by weight, the surface layer tends to have a low film strength to cause a lowering of running performance in repeated use in some cases. Also, a charge-transporting material may optionally be added in order to improve potential characteristics.

What is important to the surface layer lies in electrical resistance.

In the method of charging by direct injection of electric charges as in the present invention, the lowering of electrical resistance on the side of the image-bearing member enables the electric charges to be delivered and received in a good efficiency. Meanwhile, when the surface layer is used for a photosensitive drum, the electrostatic latent image must be held thereon for a certain time, hence the surface layer 16 as a charge injection layer may have a volume resistivity of from 1×10⁹ Ω·cm to 1×10¹⁴ Ω·cm as a suitable range. The surface layer (charge transport layer) of the photosensitive drum A has a volume resistivity of 1×10¹⁶ Ω·cm, and the surface layer of the photosensitive drum B has a volume resistivity of 4.6×10¹² Ω·cm. Therefore, the photosensitive drum A has an injection charging performance inferior to that of the photosensitive drum B.

The photosensitive drum thus produced must have a surface contact angle to water of 86° or more from the viewpoint of the uniformity of the particles on the charging roller surface, and may preferably be 103° or less from the viewpoint of providing the charging contact zone stably. The photosensitive drum A has a surface contact angle to water of 86°, and the photosensitive drum B has a surface contact angle to water of 95°. The surface contact angle to water is measured by a method making use of pure water, using as a measuring instrument a contact angle meter Model CA-DS, manufactured by Kyowa Kaimen Kagaku K.K.

The photosensitive drum is by no means limited to those described above. Any drum may be used as long as it satisfies the surface contact angle to water, and an amorphous-silicon drum may also be used. The amorphous-silicon drum has a surface with a volume resistivity of 1×10¹³ Ω·cm, and hence it is a drum suited to the injection charging.

### PRODUCTION EXAMPLE 1

Toner constituent materials in Production Example 1:

| | (by weight) |
|---|---|
| Magnetic material (magnetite) | 100 parts |
| Styrene-acrylic copolymer | 100 parts |
| Iron complex of monoazo dye (negative charge control | 2 parts |
| agent) | |
| Low-molecular-weight polyolefin (release agent) | 2 parts |

In this Production Example, magnetic toner particles produced using the above constituent materials in the aforementioned pulverization followed by classification, were subjected to surface treatment by a mechanical impact method at a temperature (Tg ±10° C.) in the vicinity of the glass transition temperature Tg of the magnetic toner particles, providing the desired particle shape. In this Example, the treatment was made at a temperature of 80° C.

Thereafter, to 100 parts by weight of the magnetic toner particles thus produced, about 1.2 parts by weight (1.2% by weight) of dry-process silica with an average primary particle diameter of 12 nm having been treated for hydrophobicity with silicone oil and hexamethyldisilazane (BET specific surface area after treatment: 120 m²/g) and about 2 parts by weight (2.0% by weight) of zinc oxide particles with an average particle diameter of 1.2 μm as the same conductive particles as those described previously were added, which were then blended by means of a mixer to produce a magnetic toner 1.

The magnetic toner 1 thus obtained had a weight-average particle diameter of 6.7 μm and an average circularity of 0.960.

### PRODUCTION EXAMPLE 2

In this Production Example, magnetic toner particles produced using the same materials as those in Example 1 by the aforementioned pulverization followed by classification, were subjected to surface treatment for making the particles spherical by agitating them at temperature of 60° C. to 80° C. in water containing a dispersant.

Thereafter, to 100 parts by weight of the magnetic toner particles thus obtained, about 1.2 parts by weight (1.2% by weight) of dry-process silica with an average primary particle diameter of 12 nm having been treated for hydrophobicity with silicone oil and hexamethyldisilazane (BET specific surface area after treatment: 120 m²/g) and about 2 parts by weight (2.0% by weight) of zinc oxide particles with an average particle diameter of 1.2 μm as the conductive particles were added, which were then blended by means of a mixer to produce a magnetic toner 2.

The magnetic toner 2 thus obtained had a weight-average particle diameter of 7.0 μm and an average circularity of 0.955.

### PRODUCTION EXAMPLE 3

In this Production Example, magnetic toner particles obtained using the same materials as those in Example 1 by the aforementioned pulverization followed by classification, were subjected to surface treatment for making the particles spherical by a heat treatment method in which they were passed through hot-air streams. In this Example, the treatment was made at a temperature of 80° C.

Thereafter, to 100 parts by weight of the magnetic toner particles thus obtained, about 1.2 parts by weight (1.2 t by weight) of dry-process silica with an average primary particle diameter of 12 nm having been hydrophobic-treated with silicone oil and hexamethyldisilazane (BET specific surface area after treatment: 120 m²/g) and about 2 parts by weight (2.0% by weight) of zinc oxide particles with an average particle diameter of 1.2 μm as the conductive particles were added, which were then blended by means of a mixer to produce a magnetic toner 3.

The magnetic toner 3 thus obtained had a weight-average particle diameter of 6.8 μm and an average circularity of 0.950.

### PRODUCTION EXAMPLE 4

In this Production Example, a toner was produced in the following way by the suspension polymerization described previously.

Into 709 g of ion-exchanged water, 451 g of an aqueous 0.1M-Na₃PO₄ solution was introduced, and the resultant mixture was heated to 60° C. Thereafter, 67.7 g of an aqueous 1.0M-CaCl2 solution was added thereto little by little to produce an aqueous medium containing Ca₃ (PO₄)₂.

| | (by weight) |
|---|---|
| Styrene | 80 parts |
| n-Butyl acrylate (monomer) | 20 parts |
| Unsaturated polyester resin | 2 parts |
| Negative charge control agent (iron compound of monoazo | 4 parts |
| dye) | |
| Surface-treated hydrophobic magnetite | 80 parts |

The above materials were uniformly mixed and dispersed by means of an attritor (manufactured by Mitsui Miike Engineering Corporation) to prepare a polymerizable monomer composition.

This polymerizable monomer composition was heated to 60° C., and 10 parts by weight of low-molecular-weight polyethylene was added thereto and mixed. In the mixture formed, 2 g of 2,2′-azobis(2,4-dimethylvaleronitrile) (t_{½}:, 140 minutes, under conditions of 60° C.) and 2 g of dimethyl-2,2′-azobisisobutyrate (t_{½}:, 270 minutes, under conditions of 60° C.; t_{½}: 80 minutes, under conditions of 80° C.) as polymerization initiators were dissolved.

This polymerizable monomer composition was introduced into the above dispersion medium, followed by stirring at 10,000 rpm for 15 minutes at 60° C. in an N₂ atmosphere by means of a TK-type homomixer (manufactured by Tokushu Kika Kogyo Co., Ltd.) to effect granulation. Thereafter, stirring with a paddle stirring blade, the reaction was carried out at 60° C. for 1 hour. Thereafter, the temperature was raised to 80° C., and the reaction was further carried out for 10 hours. After the reaction was completed, the suspension formed was cooled, and then hydrochloric acid was added to dissolve the Ca₃(PO₄)₂, followed by filtration, washing with water and drying to obtain magnetic toner particles.

Thereafter, to 100 parts by weight of the magnetic toner particles thus obtained, about 1.2 parts by weight (1.2% by weight) of dry-process silica with an average primary particle diameter of 12 nm having been hydrophobic-treated with silicone oil and hexamethyldisilazane (BET specific surface area after treatment: 120 m²/g) and about 2 parts by weight (2.0% by weight) of zinc oxide particles with an average particle diameter of 1.2 μm as the conductive particles were added, which were then blended by means of a mixer to produce a magnetic toner 4.

The magnetic toner 4 thus obtained had a weight-average particle diameter of 7.5 μm and an average circularity of 0.970.

### COMPARATIVE PRODUCTION EXAMPLE 1

In this Comparative Production Example, to 100 parts by weight of conventional-type magnetic toner particles obtained by conventional pulverization, not subjected to surface treatment, about 1.2 parts by weight (1.2% by weight) of dry-process silica with an average primary particle diameter of 12 nm having been hydrophobic-treated with silicone oil and hexamethyldisilazane (BET specific surface area after treatment: 120 m²/g) and about 2 parts by weight (2.0% by weight) of zinc oxide particles with an average particle diameter of 1.2 μm as the conductive particles were added, which were then blended by means of a mixer to produce a comparative magnetic toner.

The comparative magnetic toner thus obtained had a weight-average particle diameter of 6.7 μm and an average circularity of 0.930.

### EXAMPLES 1 TO 4 AND COMPARATIVE EXAMPLE 1

The photosensitive drum A or B described previously was set in a commercially available printer (LBP-1760) manufactured by CANON INC., which was remodeled as shown in FIG. 1. Images were reproduced using the magnetic toners produced in Production Examples 1 to 4 and Comparative Production Example 1.

Evaluation of Charging Performance:

The charging performance was evaluated by examining whether or not any lines (or streaks) appeared when reproducing an image having a solid-black area at the image leading end (an area not larger than that corresponding to one round of the drum) and a halftone in the remaining area.

Here, in order to evaluate the charging performance severely, a printing test was made using an image pattern having a print image percentage as high as 7%, which was rather high and severe for the cleanerless apparatus, and having no difference in print image percentage in its lengthwise direction.

The evaluation was made according to the following criteria. The results are shown in Table 1.

C: Black lines due to faulty charging appear on the whole halftone image.

B: The black lines appear in ghost areas of the halftone image at the first-round part following the solid-black area.

A: The halftone image is uniform and good.

Since the printer performs reverse development, the ghost referred to here means that, because of faulty charging occurring on the second round of the photosensitive drum at the part imagewise exposed (toner image area) on the first round of the photosensitive drum, the part of the previous-round image pattern on the photosensitive drum is more strongly developed to cause a ghost image. Here, the part corresponding to that position is called a ghost area, where marks of the faulty charging are liable to appear and are used for the evaluation. In addition, the gist of the present invention is to construct the apparatus so that the transfer residual toner can smoothly move in the charging contact zone is the invention, and hence the evaluation is made on what influence the transfer residual toner after the development of the solid-black area has on the charging after the first round of the photosensitive drum.

In Examples 1, 2 and 4 (the magnetic toners 1, 2 and 4), the transfer residual toner was a little mingled in the contact zone, but the magnetic toner was able to move in the contact zone and to uniformly be charged. Hence, good charging performance was achieved on every photosensitive drum, in respect of the halftone image which is severe for the evaluation of charging uniformity.

In Example 3 (the magnetic toner 3), the magnetic toner had a little low circularity, and hence it somewhat caused faulty charging. With the photosensitive drum A, sites which were somewhat not chargeable took place, and faulty charging appeared a little in stripes or lines at the ghost area following the solid-black area. However, with the photosensitive drum B having good injection performance, any faulty charging did not occur and a uniform halftone was attained.

In Comparative Example 1, the toner had so low an average circularity that, though the charging roller surface was not so contaminated and hence good charging performance was able to be achieved at the initial 100-sheet stage, the roller surface becomes contaminated by the toner during long-term service. Hence, not only the transfer residual toner after the development of the solid-black area but also that after the development of the halftone area causes sites which were not satisfactorily injection-chargeable upon contact at the charging contact zone, resulting in formation of images with lines.

The results of evaluation are shown in Table 1.

TABLE 1

| | | Charging performance | |
|---|---|---|---|
| | | when printed on 4,000 sheets | |
| | Average | after printing on 100 sheets | |
| | circularity | using photosen- | using photosen- |
| | of toner | sitive drum A | sitive drum B |
| Example: | | | |
| 1 | 0.960 | A → A | A → A |
| 2 | 0.955 | A → A | A → A |
| 3 | 0.950 | A → B | A → A |
| 4 | 0.970 | A → A | A → A |
| Comparative Example: | | | |
| 1 | 0.930 | A → C | A → C |

What is claimed is:

1. An image-forming apparatus comprising:
a charging object member;
a charging assembly which is in contact with the charging object member to electrostatically charge the charging object member;
an exposure assembly which forms an electrostatic latent image on the charging object member by exposure;
a non-contact developing assembly making use of a magnetic one-component developer, which develops the electrostatic latent image with the magnetic one-component developer to form a magnetic-toner image and collects a magnetic toner remaining on the charging object member; and
a transfer charging assembly which transfers to a recording medium the magnetic-toner image formed on the charging object member;
wherein said charging assembly comprises a charging member constituted of an elastic body having the shape of a roller and having a porous material at least on its surface, the surface of said charging member is movable with a velocity differential in the opposite direction with respect to the surface of said charging object member, and conductive particles are present at least at the contact surfaces between said charging member and said charging object member;
said velocity differential being from −101% to −400%;
said charging member having a surface roughness Ra of from 1 μm to 500 μm;
said charging object member having a surface with a contact angle to water of from 860 to 103°;
said magnetic one-component developer comprising a magnetic toner having at least a binder resin and a magnetic material, and said magnetic one-component developer having an average circularity of 0.950 or more as determined from the following equations:
$$\begin{matrix}C i r c u l a r i t y ( C i ) = \frac{\begin{matrix}Ci r c u m fe r e nt i a l l e n g t h of a \\ circle with the same area \\ as projected particle image\end{matrix}}{\begin{matrix}Circumferential length of \\ projected particle image\end{matrix}} & Equation ( 1 ) \\ A v e r a g e c i r c u l a r i t y ( \overline{C} ) = {\sum }_{i = 1}^{m} C i / m & Equation ( 2 )\end{matrix}$$

2. The image-forming apparatus according to claim 1, wherein said magnetic one-component developer has conductive particles.

3. The image-forming apparatus according to claim 2, wherein said conductive particles have a specific resistance of 1×10¹² Ω·cm or below and an average particle diameter of from 10 nm to 10 μm.

4. The image-forming apparatus according to claim 1, wherein said charging object member is an electrophotographic photosensitive member, the outer-most surface layer of which has a volume resistivity of from 1×10⁹ Ω·cm to 1×10¹⁴ Ω·cm.

5. The image-forming apparatus according to claim 1, which further comprises an intermediate transfer member, and the magnetic toner image on said charging object member is transferred to the recording medium via the intermediate transfer member.

6. The image-forming apparatus according to claim 1, wherein said charging member is a charging roller and the charging roller has a hardness of from 25 degrees to 50 degrees as Asker-C hardness.

7. The image-forming apparatus according to claim 1, wherein said conductive particles have a specific resistance of 1×10¹² Ω·cm or below.

8. The image-forming apparatus according to claim 1, wherein said conductive particles have an average particle diameter of from 0.010 μm to 10 μm.

9. An image-forming method comprising:
charging a charging object member electrostatically by means of a charging assembly which is in contact with the charging object member;
exposing the charging object member thus charged, by means of an exposure assembly to form an electrostatic latent image on the charging object member;
developing the electrostatic latent image by means of a non-contact developing assembly having a magnetic one-component developer, to form a magnetic-toner image on the charging object member;
transferring the magnetic-toner image formed on the charging object member, to a recording medium by means of a transfer charging assembly;
charging by means of the charging assembly the charging object member having thereon a magnetic toner remaining after transfer;
exposing the charging object member thus charged, by means of the exposure assembly to form an electrostatic latent image on the charging object member;
developing the electrostatic latent image with the magnetic one-component developer to form a magnetic-toner image on the charging object member, and collecting in the non-contact developing assembly the magnetic toner remaining on the charging object member; and
transferring the magnetic-toner image formed on the charging object member, to a recording medium by means of the transfer charging assembly;
wherein said charging assembly comprises a charging member constituted of an elastic body having the shape of a roller and having a porous material at least on its surface, the surface of said charging member is moved with a velocity differential in the opposite direction with respect to the surface of said charging object member, and conductive particles are present at least at the contact surfaces between said charging member and said charging object member;
said velocity differential being from −101% to −400%;
said charging member having a surface roughness Ra of from 1 μm to 500 μm;
said charging object member having a surface with a contact angle to water of from 860 to 103°;
said magnetic one-component developer comprising a magnetic toner having at least a binder resin and a magnetic material, and said magnetic one-component developer having an average circularity of 0.950 or more as determined from the following equations.
$$\begin{matrix}C i r c u l a r i t y ( C i ) = \frac{\begin{matrix}Ci r c u m fe r e nt i a l l e n g t h of a \\ circle with the same area \\ as projected particle image\end{matrix}}{\begin{matrix}Circumferential length of \\ projected particle image\end{matrix}} & Equation ( 1 ) \\ A v e r a g e c i r c u l a r i t y ( \overline{C} ) = {\sum }_{i = 1}^{m} C i / m & Equation ( 2 )\end{matrix}$$
